(19) United States
(12) Patent Application Publication
(10) Pub. No.: US 2006/0155617 A1
(43) Pub. Date: Jul. 13, 2006

(54) Money management education system, apparatus and method

(76) Inventor: Michael A. Dasilva, Tampa, FL (US)

Correspondence Address: LAW OFFICE OF CHRISTOPHER KAY, 3111 W. DR. M.L. KING JR. BLVD., SUITE 100, TAMPA, FL, 33607, US

(21) Appl. No.: 11/244,580

(22) Filed: Oct. 6, 2005

Related U.S. Application Data
(60) Provisional application No. 60/642,804, filed on Jan. 10, 2005.

(51) Int. Cl. G07F 19/00; G07B 17/00

(52) U.S. Cl. 705/30

(57) ABSTRACT

A money management training system for children or young adults providing age-appropriate training in money management skills and concepts in which a proportion of real, non-essential spending for the benefit of the child or young adult is provided to them on a periodic basis for their management and is allocated among a set of accounts for different purposes, such as investing, saving, learning, spending, and charitable donation, in predetermined proportions. Preferably, the system is supported by a webpage providing information, interest, games, good and services, and the like, for promoting the development of good financial skills.

### FIELD OF THE INVENTION

The present invention relates to a money management education system, apparatus, and method. More specifically, the present invention relates to a money management education system for providing age-appropriate training in money management skills and concepts to children and young adults through hands-on training in the management of non-essential spending organized into plurality of accounts.

### BACKGROUND OF THE INVENTION

Making, spending and managing money is a hallmark of maturity, and a person's quality of life is significantly affected by the level of skill which that person brings to the task of money management. However, the subject of money management is often ignored in the process of educating children and young adults, as illustrated by the high rate of personal bankruptcy. In 2003, more than 1.6 million people filed for personal bankruptcy in the U.S., which exceeded the number of college graduates for that year. Studies have shown that as many as 80% of North Americans do not understand finances. Further, there is a misperception that money management is generally taught in schools, and studies have shown that children of parents who lack money management skills will also likely suffer this deficiency.

Various systems for teaching money management skills have been proposed. However, these tend to be uninteresting particularly to younger children, or fail to teach important general principles, or focus too narrowly on only the management of “allowance” money rather than broader categories of spending, or otherwise fail to properly educate with respect to key concepts of money management essential for successful adult life.

U.S. Patent Application Publication US 2004/0081942 A1 to Resnick discloses internet access and management of a child's financial account coupled to interactive games teaching money management skills. Deposits to the account are tracked and parents must authorize transactions. The system relates to management of traditional savings or investment accounts rather than providing a coherent set of accounts for the management of day-to-day spending and principles for determining the proper amount to deposit into such accounts. Thus, the system teaches money management principles primarily through games.

U.S. Pat. No. 6,454,570 A1 to Woods teaches a piggy bank coupled via a network to an account, whereby the account is updated electronically regarding deposits and withdrawals so that the child becomes familiar with banking but does not physically part with the money. The system relates to a single account, and does not provide a set of accounts for organizing day-to-day spending or guidance for its use.

U.S. Pat. No. 6,224,381 B1 to Culberson et al. provides teaching materials to educate special needs children about money. A magnetic easel and graphic cards are provided. The system is not directed to management of real money, but rather to fictitious budget categories that would be appropriate for adult money management. The system is not networked.

U.S. Pat. No. 5,716,211 to Vetter teaches a microprocessor controlled savings bank divided into accounts with computations and displays for aiding investment decisions. The device is directed to the calculation of future values of investments. The device presupposes a deposit requiring allocation among accounts and does not address the origin or purpose of the deposit.

U.S. Patent Application Publication No. US 2003/0009402 A1 to Mullen et al. teaches sub-dividing a real online account into purely virtual sub-accounts to facilitate budgeting. The system is directed to adults.

Therefore, there is a need in the art for a money management teaching system for children and young adults that remedies the above-mentioned deficiencies. All this and more will be apparent to one of skill in the art upon reading the following disclosure, examples, and claims.

### SUMMARY OF THE INVENTION

It is an object of the present invention to overcome the above disadvantages of the prior art. This object is achieved according to a first aspect of the invention by a method for teaching money management skills to a child or young adult, comprising ages from approximately five years to approximately 22 years and herein termed collectively “subject,” whereby a subject learns principles of money management necessary for successful adult life including, but not limited to: distinguishing between wants and needs and understanding the necessity of meeting needs before wants; understanding the power of compound interest and acquiring the habit of consistent saving; acquiring the habits of budgeting and of planning for larger purchases; understanding the importance of delayed gratification; understanding the concept of opportunity costs with respect to spending and investment choices; acquiring the habit of prioritizing; acquiring the habit of lifelong learning through allocating funds for this purpose; understanding the concept of balance in spending including budgeting funds solely to have fun; and acquiring the habit of charitable giving.

In a first step of the method of this first aspect, the amount of non-essential spending that the parent, guardian, or the equivalent (herein collectively “parent”) of the subject already spends for the benefit of the subject is determined. Essential spending, such as for food, shelter, basic clothing and the like, is excluded as being the responsibility of the parent. The remaining non-essential spending is totaled over a certain period, such as a month, and may include spending for such items as investment, extra-curricular education, toys, fun, technology, entertainment, vacation, leisure, personal items, seasonal items, and charities, as set forth in greater detail in the following disclosure. Preferably, non-essential spending is calculated with the aid of computer program that is an optional element of the system of the present invention and which may be accessed via the internet or within a non-networked computer environment.

In a second step of the method of this first aspect, the subject is provided, for one or more subsequent time periods, a predetermined proportion of this total, such as for example one-half, to manage. The present method differs from traditional child allowances in at least that the amount of funds provided to the subject is greater and the range of purposes for which it is to be spent is larger. However, the cost to the parent or guardian remains essentially unchanged because the subject is provided with funds that were already being spent for their benefit. Further, by this method the funds are tailored to the current family lifestyle and budget. The funds are allocated according to a predetermined formula into a plurality of accounts, for example five, having designated non-essential spending purposes. The allocated funds are optionally stored in a money storage device comprising a separate compartment for each account. The subject manages these accounts in accordance with the purposes previously defined for each account. For example, funds in an account designated “Wealth” could be used for investment but not for spending. By providing the subject with more funds, and a wider scope of tasks to be accomplished with the funds, as compared to a traditional allowance system, the subject is provided greater opportunity for growth and development to learn money management skills in a safe learning environment.

According to a second aspect of the invention, the system of the present invention comprises an educational interactive method preferably performed in the context of a system comprising a network such as the internet, a data display device, a data input device and a computer operably connected to the network. A remote website provides a variety of supporting functions to the subject via a graphic user interface including providing educational games, retail opportunities, information, calculations, financial services, and the like. However, it should be understood that the method of the present invention can be practiced in a non-networked environment, or in the absence of a computer.

The system of the second aspect of the present invention can further comprise one or more linked or affiliated websites capable of providing one or more services to the user that motivate, support and encourage continued use of the system. Websites may provide, for example and without limitation: a secured personal interactive online account for tracking and analyzing user accounts; informative games to support wealth education; entertaining games to encourage continued participation in the system; games providing rewards redeemable for value from third-party vendors, for example for books, subscriptions, discounts, coupons and the like; interaction with informative and/or supportive characters; utility programs for entering, analyzing and presenting data relating to said accounts; links to third-party vendors providing preferred consumer services or benefits to a user of said system; links to third-party vendors of financial instruments, such as stocks, mutual funds, or bonds, to facilitate investment and/or offer preferred terms to a user of the system; a chat room for peer support; services providing money management advice, responses to user questions, or technical support; and links to charity related websites.

According to a third aspect of the invention, there is provided a money storage device supportive of the method of the invention and comprising a separate compartment for each said account. Each compartment is provided with means for adding and removing money, receipts or chits. The association between the system of the present invention and the money storage device can be strengthened by affixing to it account names, logos, trademarks, age-appropriate characters, and the like.

According to a fourth aspect of the invention there is optionally provided an account solely for charitable giving whereby the habit of providing for others is reinforced at an early age and the subject's self esteem is increased as the subject recognizes himself or herself as a valuable member of society. In addition, the subject thereby is taught social responsibility and a sense of community involvement.

According to a fifth aspect of the invention, the invention provides a kit for teaching money management skills comprising the money storage device and at least one money management training material that teaches or supports use of the method of the present invention.

Still other objects and advantages of the present invention will become readily apparent to those of skill in the art from the following disclosure, examples, and drawings setting forth the best mode presently contemplated for carrying out the objects of the invention. As will also be apparent, the invention is capable of modification in various obvious respects without departing from the spirit and scope of the invention. Accordingly, the drawings and description of the preferred embodiment are to be regarded as illustrative in nature, and not as limiting or restrictive.

### BRIEF DESCRIPTION OF THE DRAWINGS

FIG. 1 is a modified block diagram of the environment within which one embodiment of the present invention is practiced.

FIG. 2 is a flowchart illustrating an embodiment of the method of the present invention.

FIG. 3 is a flowchart illustrating the account user portion of a networked embodiment of the system of the present invention.

FIG. 4 is a flowchart illustrating in greater detail the step of determining non-essential spending as shown in FIG. 2.

FIG. 5 is a perspective view of one embodiment of a money storage device of the system of the present invention.

### DETAILED DESCRIPTION

The term “money management” as used herein may refer without limitation to one or more of the following money management skills: comprehension of the difference between wants and needs, and the necessity of meeting needs before wants; an understanding of the working and power of compound interest and the habit of consistent saving, and the interrelationship of time, money and interest rate; acquisition of the habit of budgeting and of planning for larger purchases; an understanding of the importance of delayed gratification to financial goal setting and achievement; an understanding of the concept of opportunity costs with respect to spending and investment choices; acquisition of the habit of prioritizing spending; acquisition of the habit of lifelong learning through allocation of funds for this purpose; acquisition of the concept of balance in spending including budgeting funds solely to have fun; and acquisition of the habit of charitable giving.

The term “non-essential spending” as used herein represents spending for or on behalf of the subject that is not essential spending. “Essential spending” may include spending for those items such as for shelter, basic food and basic clothing, whereby, if a parent was able but failed to provide those items, then the parent, in a general non-legal sense, may be considered negligent. “Non-essential spending” may include spending for one or more of finance (e.g. allowance, savings plan, college plans, or trust funds), education (e.g. books, magazines, arts and crafts, hobbies, shows, art work, electronic games, parks, zoos, museums, theatre, pens, pencils, or writing supplies), toys or fun (e.g. toys, board games, sporting goods, arcade games, video games, stuffed animals, characters, outdoor toys, water toys, posters, ice cream, candy, or trinkets), technology (e.g. computers, electronic games, software, computer programs, electronics, cell phones, or digital music), entertainment (e.g. cinemas, music, restaurants, parks, entertainment rentals, shows, concerts, sporting events, fun parks, water parks, rides, or performances), vacation or leisure (e.g. travel games, souvenirs, camera, camera film, film development, camps, camping supplies, camping equipment, tickets, or retreats), personal (e.g. gifts, cards, watches, clothes, shoes, grooming, or jewelry), seasonal (e.g. spending specific for Valentines Day, Easter, Summer, Halloween, or Christmas), and charities (e.g. a church, a charity, a food bank, a relief fund, a school, or a sponsorship), or the like.

The term “period of time” includes any period of time for which the rate of non-essential spending may reasonably or conveniently be assessed, and may include for example a week, two weeks, a month, a quarter, or a year. Preferably, a period of time of two weeks or one month is used. Most preferably, a period of time of one month is used.

The term “predetermined fraction” represents a predetermined fraction or percentage of the total non-essential spending. For example, predetermined fractions of non-essential spending could be 25%, 50%, 75% or 100%. The predetermined fraction is selected according to factors such as the maturity of the subject, comfort level of the parent or guardian, and the like. Preferably a predetermined fraction of one half or 50% is used.

The term “predetermined distribution formula” represents all of the fractions or percentages of the amounts intended for distribution into each account, the fractions summing to 1.0 (percentages to 100%).

The term “manage” as used herein represents that the subject is authorized to spend, retain, redistribute funds from, to and between accounts in accordance with the predetermined purposes of the accounts and any rules relating thereto. Thus, the authority to manage provides the subject with discretion, but only within predetermined parameters, thereby enhancing the learning experience within a controlled environment.

The term “supportive website” as used herein represents any resource accessible via a network such as the internet or an intranet and which is identified as being associated with the system of the present invention or is hyperlinked to such a resource. Supportive websites provide, for example: education; information; interest; fun; and services that support, maintain, encourage or otherwise add value for the user in the use of the system of the present invention. Supportive websites include, but are not limited to, those providing services such as: a secured personal interactive online account; informative games; entertaining games; games providing rewards redeemable for value from third-party vendors; interaction with informative and/or supportive characters; utility programs for entering, analyzing and presenting data relating to said accounts; links to third-party vendors providing preferred consumer services or benefits to a user of said system; links to third-party vendors of financial instruments to facilitate investment and/or offer preferred terms to a user of said system; a chat room for peer support; services providing money management advice, responses to user questions, or technical support; and links to charity related websites.

The term “age-appropriate” refers herein to educational material that is adapted to support the education, training and use of the system according to the age of the subject.

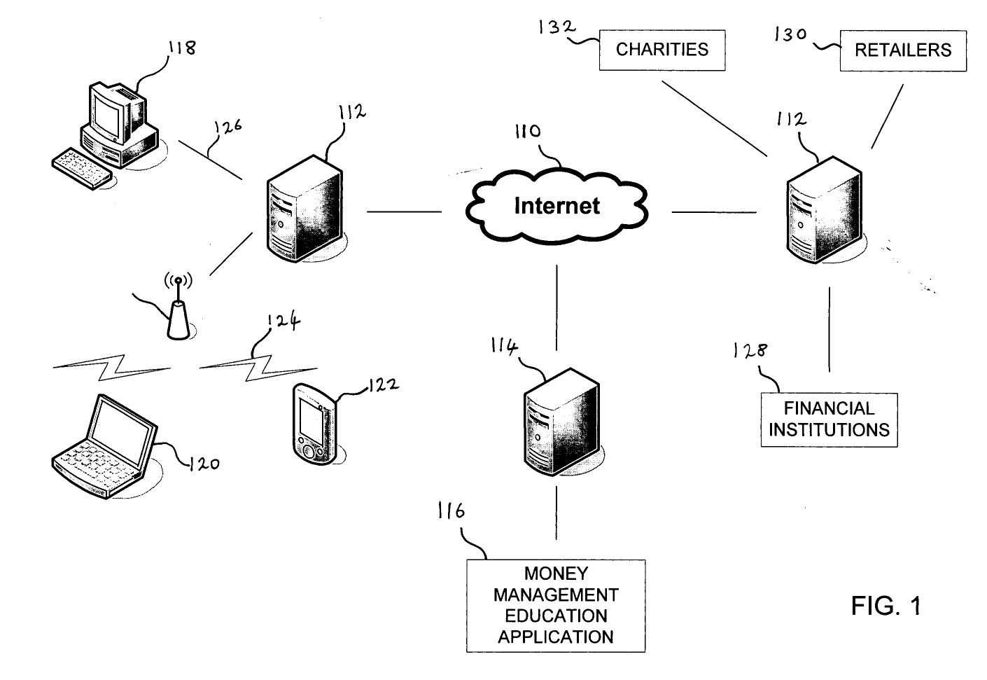

A modified block diagram of the environment within which one embodiment of the present invention can be practiced is shown in FIG. 1. This figure shows a variety of networked or internet-accessible devices operably connected to the internet 110. Access to the internet is provided via, for example, internet service providers (ISPs) 112, or via a dedicated server 114. For example, an ISP 112 or dedicated server 114 may be used to provide to a subject accessing the internet a website comprising a money management education application 116 according to the present invention. The internet 110 allows for the interconnection of the display devices of users, which can include computer terminals 118, laptops 120, personal digital assistants (PDAs) 122, or present or future equivalents thereof, which may be connected to the internet by a wired 126 or wireless (e.g. via a wireless application protocol or WAP, or infrared) connection 124. Within this exemplary environment, the display devices of users 118, 120, 122 are operably connected to a website comprising a money management education application 116 implementing or supporting the present invention. It should be noted, however, that the money management method according to the present invention is not limited to a networked or internet-based environment and can be practiced in a non-networked setting including without the use of computers.

Returning to the example of FIG. 1, the display devices of users 118, 120, 122 can be further operably connected to a variety of service providers to which a subject can be directed by, for example, selecting a hyperlink within a website comprising a money management education application 116 according to the present invention. Exemplary service providers include financial institutions 128, retailers 130, and charities 132. Such service providers can optionally provide preferred terms or services to subjects who access their websites via a website comprising a money management education application 116 according to the present invention, or by the subject providing a code or other evidence of participation in a money management education method according to the present invention. Optionally, the service provider can provide revenue or other benefit to the operator of the website comprising a money management education application 116, where the revenue is related to the subject's use of services or website visit.

More generally, in the embodiment of FIG. 1, the services provided to the subject by a money management education application 116, which represents a software implementation of the method of the present invention, can include, but are not limited to, a website capable of providing one or more of the following services, either directly or via hyperlinks to other sites: secure access to account information; informative games; entertaining games; games providing rewards redeemable for value from third-party vendors; interaction with informative and/or supportive characters; utility programs for entering, analyzing and presenting data relating to a user's accounts; links to third-party vendors providing preferred consumer services or benefits to a user of said system; links to third-party vendors of financial instruments to facilitate investment or offer preferred terms to a user; a chat room providing peer support; services providing money management advice, responses to user questions, or technical support; and links to charity related websites.

Software that implements the method of the present invention can also be used in a stand-alone mode by installing and running the software locally on a computer that may or may not be networked, whereby the subject can track accounts and progress toward financial goals without the requirement for an internet connection.

According to the embodiment of FIG. 1, a subject operating a computer, data input device, and display, operably connected to a network such as the internet and a website providing a software implementation of the method of the present invention is provided with a means of accessing goods and services related to the method of the present invention. The software implementation of the method of the present invention according to FIG. 1 further includes a means for determining non-essential spending expended for the subject over a predetermined period of time, which can include without limitation an online or printable worksheet, an online calculator, written guidelines or suggestions (e.g. in the form of a listing of frequently asked questions or “FAQ”), or the equivalent thereof. The software implementation of the method of the present invention according to FIG. 1 further includes a means for distributing a predetermined fraction of the non-essential spending among a plurality of accounts according to a predetermined distribution formula for at least one period of time, wherein each said account has a predetermined non-essential spending purpose. For example, the program may distribute predetermined fractions of non-essential spending among virtual online accounts to reflect actual distributions of funds performed at the user's location. The software implementation of the method of the present invention according to FIG. 1 further includes means for managing the accounts in accordance with each their predetermined purposes by the child or young adult. Such means may include, for example, the manipulation of online virtual accounts whose transactions are matched by corresponding real transactions at the user's location, or the online accounts may be configured to be capable of real transactions, for example as traditional online accounts held at financial institutions and used for online transactions.

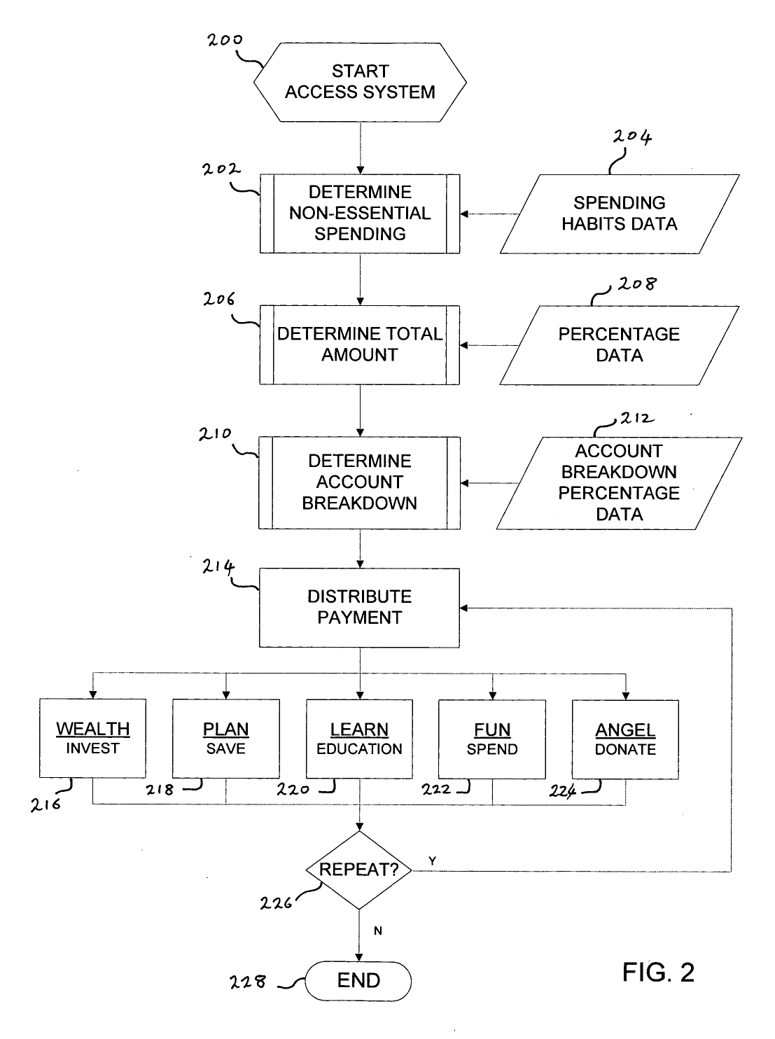

Turning now to FIG. 2, an embodiment of the method of the present invention within the context of FIG. 1 for teaching money management skills to a child or young adult is shown.

In a first step, a parent or guardian, or the equivalent thereof (collectively “parent”) accesses the system 200 by, for example, registering or establishing a new account for the subject at the website. This step can comprise establishing one or more online banking or investment accounts for the subject corresponding to one or more of the plurality of accounts of the method of the present invention.

In a second step, the amount of non-essential spending expended by the parent for the subject over a predetermined period of time is determined 202 using spending habits data 204 input by the parent, for example in response to specific prompting and questions presented at the website. The non-essential spending is totaled 206, and the parent can input percentage data 208 representing the predetermined fraction of the non-essential spending that the parent wishes the subject to manage.

In a third step, the predetermined fraction of the non-essential spending is allocated to the subject's accounts, each of which has a predetermined non-essential spending purpose, according to an account breakdown 210. The predetermined fraction of the non-essential spending can be allocated by any suitable method including but not limited to distribution of cash, by online electronic transfer by a parent from one account to another, or by check. The parent determines the account breakdown by entering or selecting account breakdown percentage data 212.

In a fourth step, payments are distributed 214 according to the account breakdown 210. Payment distribution may be in any form that provides the subject with authority over the use of the distributed funds consistent with the predetermined purpose and/or rules of each account. For example, funds can be distributed in cash, in the form of IOUs or written notes, into online virtual or actual accounts, placed onto cash cards or debit cards or equivalent instruments, or deposited offline into real accounts, or a combination thereof.

In a preferred embodiment, the following series of transfers can occur. A parent first deposits the entire predetermined fraction of the non-essential spending into the subject's online account by an electronic transfer. Next, the subject allocates a predetermined amount into a “Wealth” account, which may be a sub-account of the subject's online account or an investment account held at a different financial institution reached via a hyperlink. Optionally, the subject may choose to further divide and distribute the funds among different investment instruments such as certificates of deposit (CDs) or other interest-bearing investments representing different tradeoffs between risk and return. For example, by use of the GUI the subject further divides and distributes the “Wealth” funds among CDs having interest rates of 4-6%, 6-8%, or more, according to the deposit term and amount deposited. The subject then allocates a predetermined amount into a “Plan” account for longer term saving towards larger purchases. Subsequent transfers to the “Learn” and “Fun” accounts causes these funds to be transferred in whole or in part to one or more cash cards, whereby the subject can spend the finds by presenting the cash card for payment. Finally, a predetermined amount is transferred to the charitable cause or causes that the subject has chosen as recipients of the funds in the “Angel” account. This transfer is performed online for example by electronic transfer to a charitable organization hyperlinked to the subject's account.

Returning to the embodiment of FIG. 2, funds are distributed into accounts for investment (“Wealth”) 216 for purchasing items sufficiently costly to require planning over more than one period of time (“Plan”) 218, for educational goods or services (“Learn”) 220, for purchasing goods or services for personal enjoyment. (“Fun”) 222, and for charitable donation and helping others (“Angel”) 224. Preferably, funds are distributed to the “Wealth” account first, in order to instill the known money management skill of “paying oneself first.” In a fifth step, the subject manages the distributed funds consistent with the predetermined purpose and/or rules of each account. In a sixth step, the distribution of funds is repeated 226 for at least one predetermined subsequent period of time, such as for example monthly, weekly, or quarterly, until a decision is made by the parent to end 228 participation. It is contemplated that the calculation of non-essential spending and the distribution can be adjusted, for example as the subject grows or matures.

The method of the present invention optionally further comprises providing age-appropriate money management training materials to the subject. Age-appropriate money management training materials include, for example, computer programs, books, stickers, magazines, television programs, videos, DVD's, telephonic assistance, assistance by a coach or mentor, or a combination of the above. For example, in a preferred embodiment a subject is provided with a folder comprising: a calendar, an agreement signed by parent and child setting forth the terms of the non-essential spending allocation, a guide describing the operation of the method of the present invention, stickers for showing disbursement dates and the like on the calendar, a folder or other container for keeping receipts or money for each account, a calculator, a tracking notebook for recording the subject's progress with respect to each account, and a card for each account recording compliance with the method of the present invention for the purpose of earning rewards.

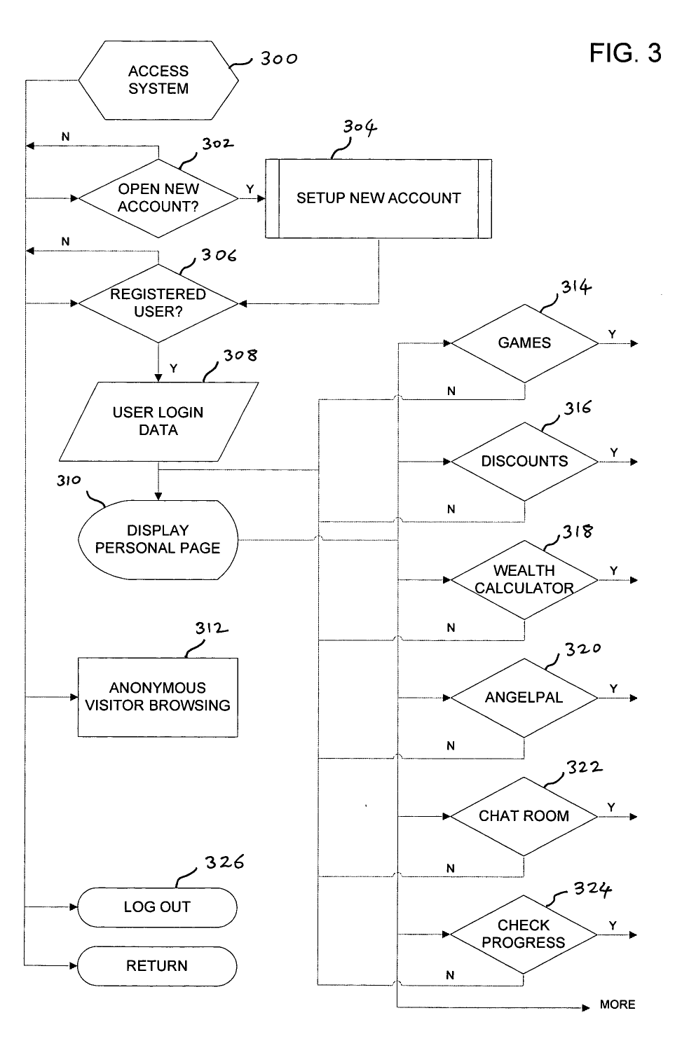

With respect to the embodiment of FIG. 1, one portion of the method is commenced when a subject accesses the application 116 start page. A flowchart of this portion of the method is shown in FIG. 3. This portion of the method commences when the application 116 displays a start page 300 that gives a subject a series of options. This application start page 300 can be accessed in a variety of ways, including through the internet directly to the start page; or through software loaded locally onto a display device of a personal computer. At the start page 300, the parent has the option to create an account 302, to login to the subject's personal page 310 and access an existing account 306, 308, to “browse” the site as an anonymous visitor 312, or to exit the application 326.

If the subject is an account holder and wishes to access their existing account, a login screen 308 is displayed. After the account holder has given the appropriate password, the application verifies the password and displays a personal page or graphic user interface (GUI) 310 to the account holder.

This personal page 310 can optionally be customized by the account holder to reflect personal choices, attitudes, age, or personality. This personalization feature allows for customizing of the personal page 310 as the account holder's interests change and mature. This allows the account holder to gain familiarity and competency with money management by visually presenting information relating to money management in an age-appropriate manner.

The personal page 310 can optionally include reports and information from a variety of sources such as financial and news reporting services, entertainment services for children, and information regarding hobbies or pastimes, and other sources of information or features selectable by the account holder. In one embodiment, the actions and selections of the account holders are monitored to obtain information regarding their favorite areas and activities. A small file or cookie may be transferred for this purpose, as is known in the art. A personalization engine may then use these monitored specific inputs to modify the display, or to make inferences to push useful information and more challenging activities to the user.

The personal page 310 offers a user a variety of options. Account holders may have the ability to personalize their page 310, play games that may teach financial management skills 314, link to vendor web pages providing discounts or other benefits 316, use various tools that facilitate financial management such as a wealth calculator 318 capable of calculating, displaying and manipulating financial data relating to investments or saving plans, link to services related to charitable giving such as charity websites or providing communication with recipients of the user's charitable giving 320, visit chat rooms or the like for peer support related to learning financial management, view the status of their accounts to see, for example, progress 324 towards saving goals such as the purchase of a costly item such as a bicycle or computer, or other services furthering the learning of financial management skills. By selecting the activity, the account holder is then able to engage in the activity.

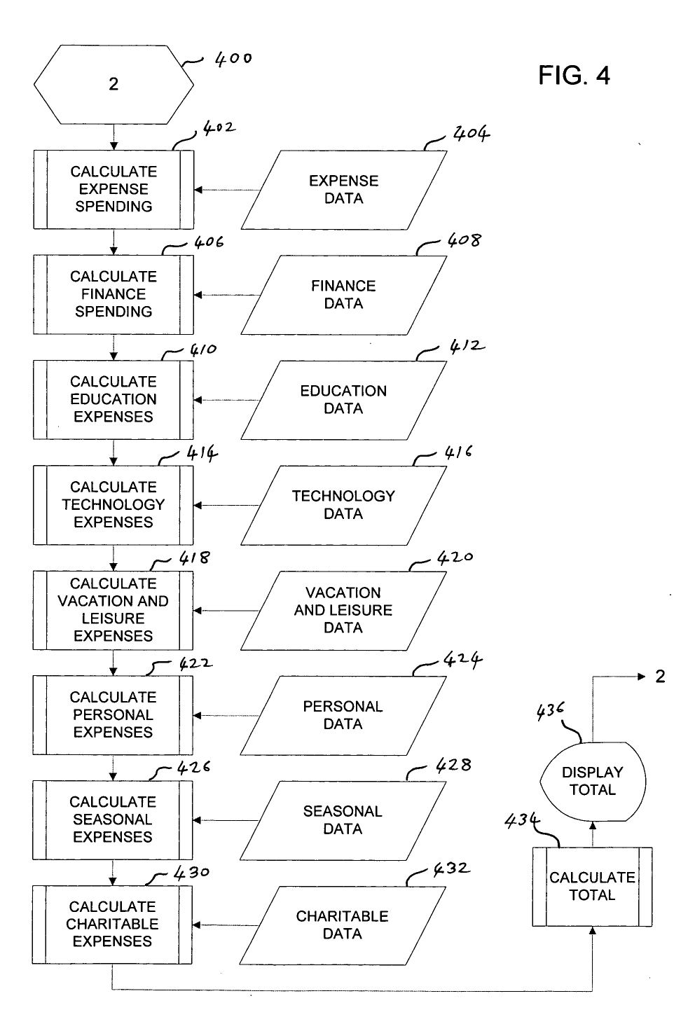

Referring now to FIG. 4, one embodiment of an allowance planner for the determination of non-essential spending 202 is shown with reference 400 to the embodiment of FIG. 2.

In this preferred embodiment, the determination of non-essential spending is illustrated as a series of steps in which the parent is prompted to enter non-essential spending 404, 408, 412, 416, 420, 424, 428 and 432 according to a set of non-essential spending categories 402, 406, 410, 414, 418, 422, 426, and 430. The breakdown of spending categories reduces the risk that non-essential spending is incorrectly estimated.

For example, the following illustrative categories can be used. Finance spending 406 can include spending for an allowance, savings plan, college plan, or trust fund. Education spending 410 can include spending for books, magazines, arts and crafts, hobbies, shows, art work, electronic games, parks, zoos, museums, theatre, pens, pencils, and writing supplies. Personal or fun spending 422 can include spending on toys, board games, sporting goods, arcade games, video games, stuffed animals, characters, outdoor toys, water toys, posters, ice cream, candy, and trinkets. Technology spending 414 can include spending on computers, electronic games, software, computer programs, electronics, cell phones, and digital music. Entertainment spending can include spending for cinemas, music, restaurants, parks, entertainment rentals, shows, concerts, sporting events, fun parks, water parks, rides, or performances. Vacation spending can include spending on travel games, souvenirs, camera, camera film, film development, camps, camping supplies, camping equipment, tickets, or retreats. Personal expenses can include spending on one or more of gifts, cards, watches, clothes, shoes, grooming, or jewelry. Seasonal expenses can include spending related to, for example, Valentines Day, Easter, summer, Halloween, or Christmas. Charitable expenses can include spending on a church, a charity, a food bank, a relief fund, a school, or a sponsorship. The categories of expense are then totaled 434, and the total is displayed 436.

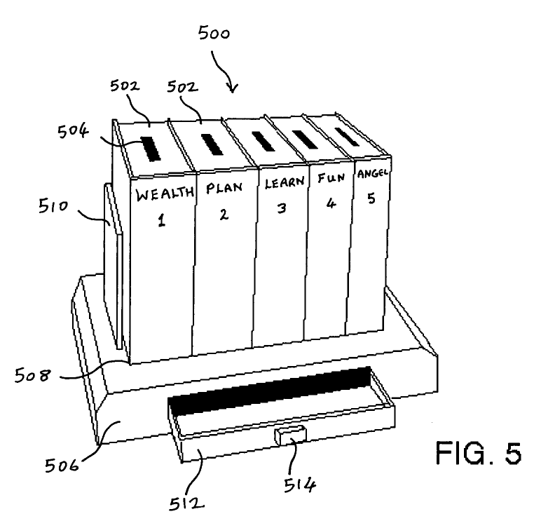

FIG. 5 shows a perspective view of a preferred embodiment of a money storage device 500 which is an optional component of the system of the present invention. The optional money storage device of FIG. 5 can be constructed of any durable material, such as metal, wood, plastic or card, and comprises a plurality of compartments 502, preferably five, in which each compartment 502 corresponds to an account, and each compartment comprises a means for placing money in said compartment (e.g. a sealable or non-sealable opening, or a slot) 504 and similar means for removing money from said compartment. Optionally, each compartment comprises a booklet stored within the compartment providing guidance on the use of that account. Each compartment can be labeled with its corresponding account and the compartments are preferably constructed to resemble books, which may optionally be arranged on a stand 506 adapted to store the compartments 502. A further optional compartment 512, preferably in the form of a drawer, can be provided within stand 506 to provide further storage space and can comprise a lock. In use, objects of value, materials related to use of the system of the present invention such as a booklet, or the like, can be stored in compartment 512.

It will be readily apparent that the above description enables the provision and implementation of a money management education system. It will also be understood that the detailed embodiment is presented only as an example of an implementation, and that many modifications and variations are possible with the spirit and scope of the invention.

Now that the invention has been described:

What is claimed is:

1. A method for teaching money management skills to a child or young adult using real money, the method comprising:
(a) determining the amount of non-essential spending expended for said child or young adult over a predetermined period of time;
(b) distributing a predetermined fraction of said non-essential spending among a plurality of accounts according to a predetermined distribution formula for at least one subsequent period of time, wherein each said account has a predetermined non-essential spending purpose; and
(c) permitting the child or young adult to manage the accounts in accordance with each said purpose,
whereby the child or young adult learns money management skills.

2. The method of claim 1, further comprising providing at any stage one or more age-appropriate money management training materials to the child or young adult.

3. The method according to claim 2, in which the age-appropriate money management training materials are selected from the group consisting of computer programs, books, stickers, magazines, television programs, videos, DVD's, telephonic assistance, assistance by a coach or mentor, and a combination thereof.

4. The method according to claim 1, wherein said plurality of accounts is five accounts.

5. The method according to claim 1, wherein at least one of said accounts is labeled “Wealth”, “Plan”, “Learn”, “Fun”, or “Angel”.

6. The method according to claim 5 wherein said accounts are labeled “Wealth”, “Plan”, “Learn”, “Fun”, and “Angel”.

7. The method according to claim 6, wherein said predetermined formula comprises at least one of: 30% to the “Wealth” account; 20% to the “Plan” account; 20% to the “Learn” account; 20% to the “Fun” account; or 10% to the “Angel” account.

8. The method according to claim 1, wherein the amount of non-essential spending is determined by adding the amount expended for at least two or more spending categories selected from the group consisting of finance, education, toys, fun, technology, entertainment, vacation, leisure, personal, seasonal, and charitable.

9. The method according to claim 1, wherein said predetermined fraction is one half.

10. The method according to claim 1, wherein said predetermined period of time is one month.

11. The method according to claim 1, comprising using a computer running a computer program for determining the amount of non-essential spending.

12. The method according to claim 11, wherein the computer program is accessed via the internet.

13. The method according to claim 1, wherein each said account is associated with an age-appropriate character.

14. A system for teaching money management skills to a child or young adult, the system comprising:
means for determining non-essential spending expended for said child or young adult over a predetermined period of time; and
means for distributing a predetermined fraction of said non-essential spending among a plurality of accounts according to a predetermined distribution formula for at least one subsequent period of time, wherein each said account has a predetermined non-essential spending purpose; and
means for managing said accounts in accordance with each said purpose by the child or young adult.

15. The system of claim 14, further comprising means for providing goods and services to said child or young adults.

16. The system of claim 14, wherein at least one of said means for providing goods and services comprises a computer, data input device and display operably connected to a network.

17. The system of claim 16, wherein at least one of said means comprises a supporting website.

18. The system of claim 17, wherein said website is capable of providing one or more services selected from the group consisting of secure access to account information; informative games; entertaining games; games providing rewards redeemable for value from third-party vendors; interaction with informative and/or supportive characters; utility programs for entering, analyzing and presenting data relating to said accounts; links to third-party vendors providing preferred consumer services or benefits to a user of said system; links to third-party vendors of financial instruments to facilitate investment and/or offer preferred terms to a user of said system; a chat room for peer support; services providing money management advice, responses to user questions, or technical support; and links to charity related websites.

19. The system of claim 14, wherein said means for managing said accounts comprises a money storage device, wherein said device comprises a plurality of compartments, each compartment corresponding to one said account, and each compartment comprising means for placing money in said compartment and means for removing money from said compartment.

20. The money storage device of claim 19 further comprising an instruction booklet for each said account.

21. The money storage device of claim 19, further comprising a lockable compartment.

22. The money storage device of claim 19, wherein each said compartment is essentially in the shape of a book.

23. The money storage device of claim 22, wherein the book-shaped compartments are detachably connected to resemble adjacent books on a bookshelf.

24. The method according to claim 1, further comprising providing a financial calculator capable of calculating the time required to reach a predetermined investment value upon a user entering a rate of saving and an interest rate.

25. A kit for teaching money management skills to a child or young adult comprising the money storage device of claim 29 and at least one money management training material.

26. The kit of claim 25 wherein said training material is selected from the group consisting of a computer program, a book, a sticker, a magazine, a video, a DVD, and a combination thereof.
